(19) United States
(12) Patent Application Publication
(10) Pub. No.: US 2013/0155041 A1
(43) Pub. Date: Jun. 20, 2013

(54) DISPLAY CONTROL DEVICE AND CONTROL METHOD FOR DISPLAY CONTROL DEVICE

(71) Applicant: CANON KABUSHIKI KAISHA, Tokyo (JP)

(72) Inventor: Shotaro Yanai, Tokyo (JP)

(73) Assignee: CANON KABUSHIKI KAISHA, Tokyo (JP)

(21) Appl. No.: 13/714,077

(22) Filed: Dec. 13, 2012

(30) Foreign Application Priority Data
Dec. 15, 2011 (JP) 2011-274725

(51) Int. Cl. G09G 5/00

(52) U.S. Cl. CPC G09G 5/003
USPC 345/207

(57) ABSTRACT

A display control device including a display unit includes a proximity detection unit configured to output a proximity detection signal when a predetermined condition to determine whether an object approaches the display control device is satisfied, an illuminance detection unit configured to detect illuminance of ambient light, and a control unit configured to control the display unit not to be turned off when the proximity detection unit outputs the proximity detection signal while the illuminance of ambient light detected by the illuminance detection unit is greater than a predetermined value, and to control the display unit to be turned off when the proximity detection unit outputs the proximity detection signal while the illuminance of ambient light detected by the illuminance detection unit is equal to or less than the predetermined value.

### BACKGROUND OF THE INVENTION

1. Field of the Invention

The present invention relates to a display control device and a control method for the display control device, particularly to a display control device which turns off a display device when an object approaches the display device.

2. Description of the Related Art

Conventionally, in order to determine whether a user is using a viewfinder, an image capturing apparatus provided with a proximity detection device has been known. Generally, a proximity detection device mainly including a light projecting unit and alight receiving unit is known. The light projecting unit projects infrared light, so that the proximity detection unit determines the presence or absence of an approaching object according to the amount of reflected infrared light that is received by the light receiving unit.

In an image capturing apparatus discussed in Japanese Patent Application Laid-Open No. 2008-258969, for example, a technique for saving electric power in a digital single lens reflex camera is proposed. In Japanese Patent Application Laid-Open No. 2008-258969, a backlight of a display device on the rear surface of the image capturing apparatus is turned off when a proximity detection device detects that a user is using a viewfinder.

Further, in a mobile phone terminal, when a user makes a call by holding the mobile phone terminal close to his/her ear, the user does not have to see a display unit (display device). Therefore, turning on the illumination of the display unit during the call may result in waste of electric power. In addition, if the light is emitted from the display unit of the mobile phone terminal that is held closer to the user's head (ear), there may be a case where the display unit is too bright for the user.

In order to solve the above-described problem, Japanese Patent Application Laid-Open No. 2005-278043 discusses a display control method for a mobile phone. In the display control method, a backlight of a display unit and/or an operation unit is turned off (shut off) to avoid unnecessary electric power consumption when it is detected that the mobile phone approaches the user's ear.

However, with the above-described conventional techniques discussed in Japanese Patent Application Laid-Open No. 2008-258969 and Japanese Patent Application Laid-Open No. 2005-278043, there is a risk in which the proximity detection device may malfunction under the ambient light having high illuminance. When the illuminance of the ambient light is high, for example, an infrared light component, which is contained in the ambient light, increases. Thus, the proximity detection device can make false detection. In a case where the false detection occurs, there is a problem in that the backlight of the display device is turned off even if the user's eye or the ear does not approach the image capturing apparatus or the mobile phone to look into the viewfinder or to make a call.

### SUMMARY OF THE INVENTION

The present invention is directed to a display control device capable of preventing a display device from being turned off although a target detection object does not approach the display device.

According to an aspect of the present invention, a display control device including a display unit includes a proximity detection unit configured to output a proximity detection signal when a predetermined condition to determine whether an object approaches the display control device is satisfied, an illuminance detection unit configured to detect illuminance of ambient light, and a control unit configured to control the display unit not to be turned off when the proximity detection unit outputs the proximity detection signal while the illuminance of ambient light detected by the illuminance detection unit is greater than a predetermined value, and to control the display unit to be turned off when the proximity detection unit outputs the proximity detection signal while the illuminance of ambient light detected by the illuminance detection unit is equal to or less than the predetermined value.

According to an exemplary embodiment of the present invention, the display device can be prevented from being turned off although a target detection object does not approach the display device.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a configuration example of an image capturing apparatus according to an exemplary embodiment of the present invention.

FIG. 2 is a diagram illustrating a configuration of a back side of the image capturing apparatus according to the exemplary embodiment of the present invention.

FIG. 3 is a block diagram illustrating a configuration example of a proximity detection device according to the exemplary embodiment of the present invention.

FIG. 4 is a flowchart illustrating proximity detection processing according to a first exemplary embodiment, which takes the illuminance into consideration.

FIGS. 5A, 5B, and 5C are diagrams illustrating on and off states of a display device according to the first exemplary embodiment, the display device being turned on and off according to the states of a proximity detection signal and an illuminance value.

FIG. 6 is a flowchart illustrating proximity detection processing according to a second exemplary embodiment, which further takes an electrical power saving into consideration.

FIG. 7 is a diagram illustrating an application example of a mobile phone according to a third exemplary embodiment of the present invention.

### DESCRIPTION OF THE EMBODIMENTS

Various exemplary embodiments, features, and aspects of the invention will be described in detail below with reference to the drawings.

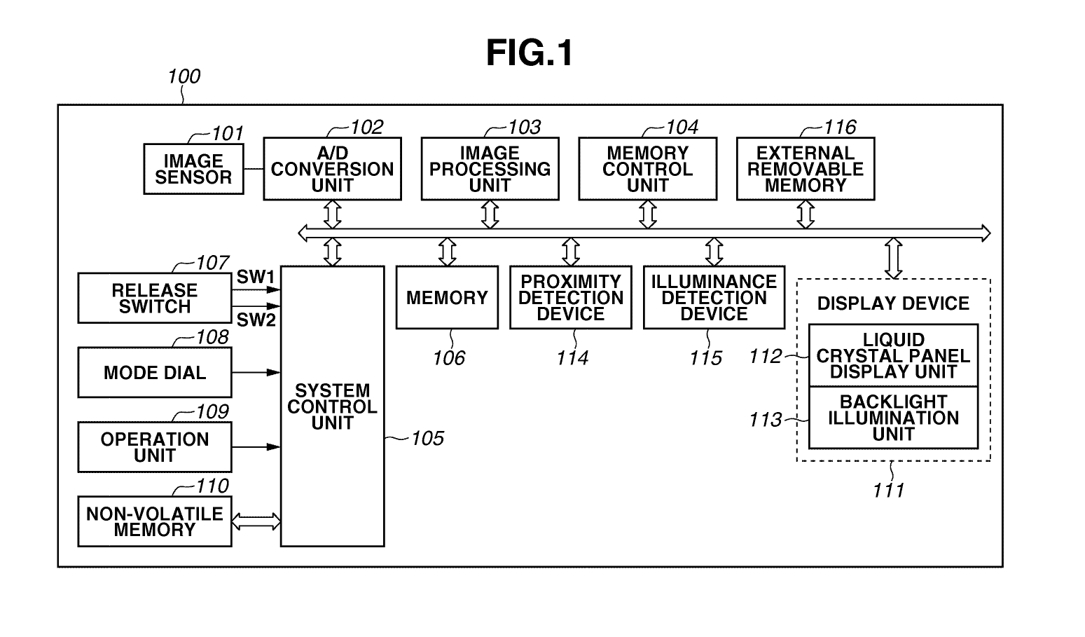

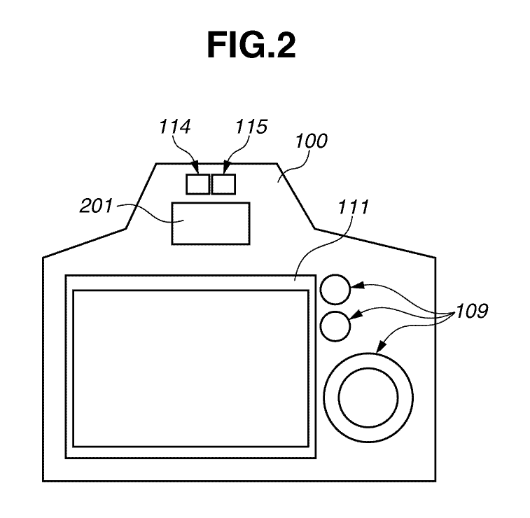

FIG. 1 is a block diagram illustrating an example of an internal configuration of an image capturing apparatus which includes a display device according to an exemplary embodiment of the present invention. FIG. 2 is a diagram illustrating a configuration of a back side of the image capturing apparatus according to the exemplary embodiment of the present invention.

As illustrated in FIG. 1, an image capturing apparatus 100 includes an image sensor 101. When a release switch 107 is pressed, the image sensor 101 converts an optical image formed through a lens (not illustrated) into an electrical signal. An analog-digital (A/D) conversion unit 102 converts an analog signal that is output from the image sensor 101 into a digital signal. The digital signal that has been converted through the A/D conversion by the A/D conversion unit 102 is controlled by a memory control unit 104 and a system control unit 105, so as to be stored in a memory 106.

An image processing unit 103 performs predetermined pixel interpolation processing and color conversion processing with respect to a digital signal data and a data that is read out from the memory 106 by the memory control unit 104. The memory control unit 104 controls data exchange performed between the A/D conversion unit 102, the image processing unit 103, the system control unit 105, the memory 106, and a display device 111. The system control unit 105 controls the entire operations of the image capturing apparatus 100.

A program stack region, a status storage region, a calculation region, a work region, and an image display data region for the system control unit 105 are reserved in the memory 106. The system control unit 105 uses the calculation region in the memory 106, and executes various kinds of calculations.

A mode dial 108 switches settings of image capturing modes with various functions such as an automatic capturing mode, a programming capturing mode, a shutter speed-priority capturing mode, an aperture-priority capturing mode, a manual capturing mode, a portrait capturing mode, a landscape capturing mode, a sports capturing mode, a night view capturing mode, and a moving image capturing mode.

An operation unit 109 receives various operational instructions for the system control unit 105. The operation unit 109 includes one of or combinations of a switch, a dial, a touch panel, a pointing device employing line-of-sight detection, and a voice recognition device.

A non-volatile memory 110 is an electrically erasable-recordable memory. A flash memory and an electrically erasable programmable read-only memory (EEPROM) can be employed as the non-volatile memory 110, for example. A state of a captured image and a program for controlling the image capturing apparatus 100 are saved and stored in the non-volatile memory 110. An external removable memory 116 is a recording medium such as CompactFlash (registered trademark) or a secure digital (SD) card. An image file is recorded onto and read out from the external removable memory 116.

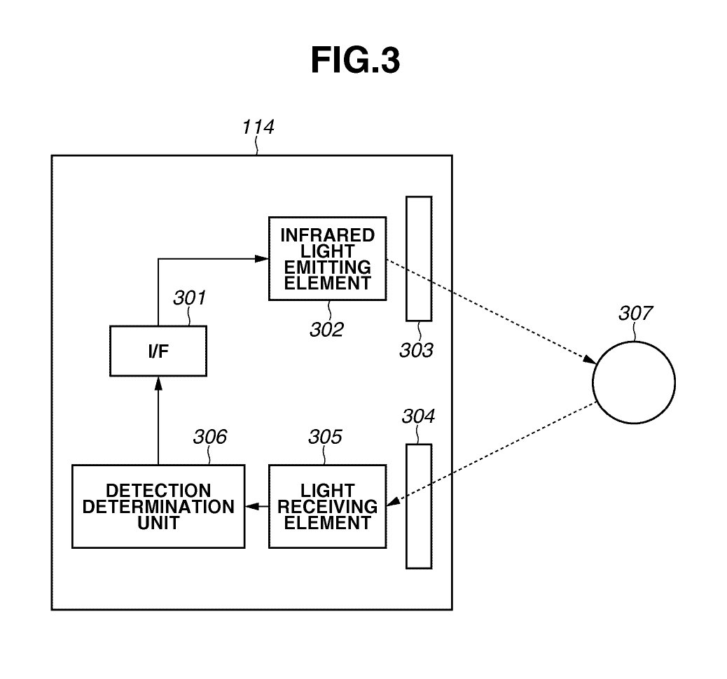

According to an instruction from the system control unit 105, a liquid crystal display device 111 displays a menu screen stored in the image display data region of the memory 106, and still image and moving image files stored in the external removable memory 116. The display device 111 includes a liquid crystal panel display unit 112 and a backlight illumination unit 113. The liquid crystal panel display unit 112 displays the still image and moving image files. The backlight illumination unit 113 irradiates the liquid crystal panel display unit 112 with light from behind. A proximity detection device 114 detects an approaching object, and outputs a proximity detection signal. A configuration of the proximity detection device 114 of the image capturing apparatus 100 according to the present exemplary embodiment is illustrated in FIG. 3. Further, the display device 111 is configured in such a manner that a touch detection sensor (not illustrated) is disposed on the display device 111 in an overlapping manner, thus the display device 111 functions as a touch panel.

In the image capturing apparatus 100, the system control unit 105 controls the proximity detection device 114 via an interface (I/F) 301 illustrated in FIG. 3, whereas the proximity detection device 114 notifies the system control unit 105 of a detection result via the I/F 301. An infrared light emitting element 302 emits a predetermined amount of infrared light through an infrared light emitting lens window 303. The infrared light which is emitted through the infrared light emitting lens window 303 disperses after reflecting on a detection target object 307. A light receiving element 305 receives the dispersed infrared light that is collected through a light receiving lens window 304, and performs photoelectric conversion.

A detection determination unit 306 compares a voltage value, which is photoelectrically converted by the light receiving element 305, with a predetermined threshold value. When the voltage value obtained through the photoelectric conversion is greater than the predetermined threshold value, the proximity detection device 114 outputs a proximity detection signal. The proximity detection device 114 outputs a face-absence detection signal when the voltage value acquired by the photoelectric conversion is equal to or less than the predetermined threshold value.

In FIG. 2, an illuminance detection device 115 detects the illuminance of ambient light. When a light receiving element (not illustrated) performs photoelectric conversion of the light that is received through a light receiving lens window (not illustrated), the illuminance detection device 115 detects the illuminance level of the ambient light.

In the present exemplary embodiment, the proximity detection device 114 is employed to detect the eye-access with respect to a viewfinder 201, and the illuminance detection device 115 is employed to detect the illuminance in the periphery of the viewfinder 201. Therefore, as illustrated in FIG. 2, the configuration may desirably be such that the proximity detection device 114 and the illuminance detection device 115 are disposed in the vicinity of the viewfinder 201.

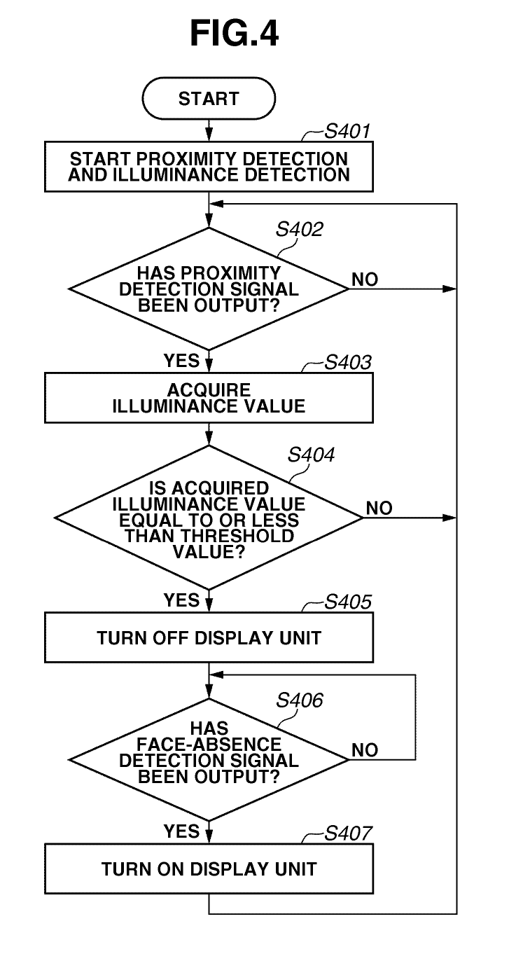

Herein, a proximity detection operation performed by the image capturing apparatus 100 according to a first exemplary embodiment of the present invention will be described with reference to a flowchart in FIG. 4. In the present exemplary embodiment, a method of preventing the display device 111 from being erroneously turned off when the proximity detection device 114 malfunctions due to the influence of ambient light will be described. The processing illustrated in FIG. 4 is realized when the system control unit 105 executes the program stored in the non-volatile memory 110 by loading the program onto the memory 106.

In step S401, the system control unit 105 respectively controls the proximity detection device 114 and the illuminance detection device 115 to start a proximity detection operation and an illuminance detection operation.

In step S402, the system control unit 105 determines whether the proximity detection device 114 outputs a proximity detection signal. If the system control unit 105 determines that the proximity detection signal is output (YES in step S402), the processing proceeds to step S403. If the system control unit 105 determines that the proximity detection signal is not output (NO in step S402), the proximity detection device 114 continues the proximity detection operation.

In step S403, the system control unit 105 acquires an illuminance value detected by the illuminance detection device 115, and stores the illuminance value in the memory 106. Even if the system control unit 105 determines that the proximity detection device 114 outputs the proximity detection signal in step S402, the system control unit 105 cannot determine precisely whether the viewfinder 201 is actually in use. The proximity detection device 114 controls the output of the detection signal according to the reflected light amount of the emitted infrared light. However, when the illuminance level of the ambient light is higher, an infrared light component contained in the ambient light is greater. Therefore, even if the viewfinder 201 is not in use, the proximity detection device 114 can output the proximity detection signal because the amount of infrared light received by the light receiving element 305 of the proximity detection device 114 may exceed the threshold value. Therefore, in the present exemplary embodiment, the system control unit 105 acquires an illuminance value in step S403, and determines whether the viewfinder 201 is in use by taking into consideration the illuminance value in addition to the presence or absence of the proximity detection signal.

In step S404, the system control unit 105 determines whether the illuminance value acquired in step S403 is equal to or less than a predetermined threshold value. If the illuminance value is equal to or less than a predetermined threshold value (YES in step S404), it is assumed that the light supplied to the illuminance detection device 115 is blocked and the illuminance level becomes low due to use of the viewfinder 201. Therefore, the system control unit 105 determines that the proximity detection signal detected in step S402 is output due to the actual use of the viewfinder 201. Then, the processing proceeds to step S405. On the contrary, if the illuminance value acquired in step S403 is greater than the threshold value (NO in step S404), the system control unit 105 determines that the proximity detection signal detected in step S402 is output due to false detection caused by the infrared light component contained in the ambient light. Therefore, the system control unit 105 causes the proximity detection device 114 to continue the proximity detection operation.

In step S405, the system control unit 105 turns off the display device 111 because the system control unit 105 determines that the viewfinder 201 is in use (i.e., eye-access state) in step S404. Through this, brightness of the display device 111 caused by the light supplied from the backlight illumination unit 113 is reduced, and the electric power can be saved. In addition, in order to prevent an erroneous operation due to the user's nose touching the display device 111 (touch panel) while the user looks into the viewfinder 201, the system control unit 105 changes an input setting of the touch panel to disable a touch input with respect to at least part of the touch panel.

In step S406, the system control unit 105 determines whether the proximity detection device 114 outputs a face-absence detection signal. In a case where the system control unit 105 determines that the face-absence detection signal is output (YES in step S406), this indicates that the user's face moves away from the viewfinder 201. Therefore, the processing proceeds to step S407. In a case where the system control unit 105 determines that the face-absence detection signal is not output (NO in step S406), this indicates that the viewfinder 201 is still in use. Therefore, the system control unit 105 keeps the display device 111 to be turned off.

In step S407, the system control unit 105 turns on the display device 111 because the system control unit 105 detects in step S406 that the user's face has moved away from the viewfinder 201. Further, the system control unit 105 changes the input setting of the touch panel to enable the touch input with respect to the display device 111 (touch panel). Thereafter, the processing returns to step S402, and the proximity detection device 114 restarts the proximity detection operation.

In the image capturing apparatus 100 according to the present exemplary embodiment, a method for preventing the display device 111 from being erroneously turned off when the proximity detection device 114 malfunctions due to the influence of the ambient light has been described.

As described above, in the present exemplary embodiment, the system control unit 105 refers to the illuminance level detected by the illuminance detection device 115 along with the presence or absence of the proximity detection signal that is output from the proximity detection device 114. Thus, the system control unit 105 can check and determine whether the proximity detection device 114 makes false detection caused by the infrared components of the ambient light. As a result, the system control unit 105 can prevent the erroneous operations such as turning off the display device 111 or disabling the touch panel input even though the viewfinder 201 is not in use.

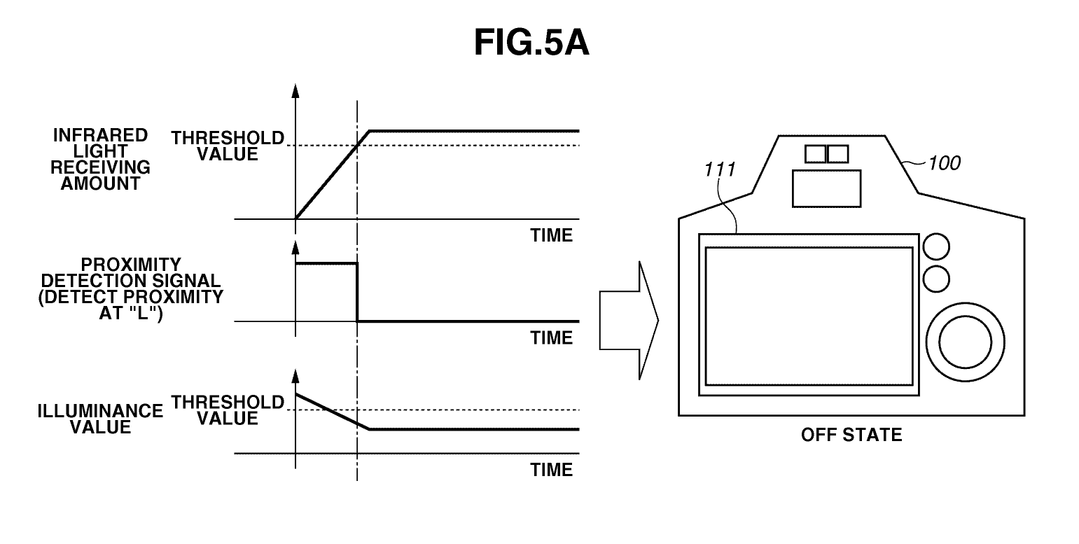

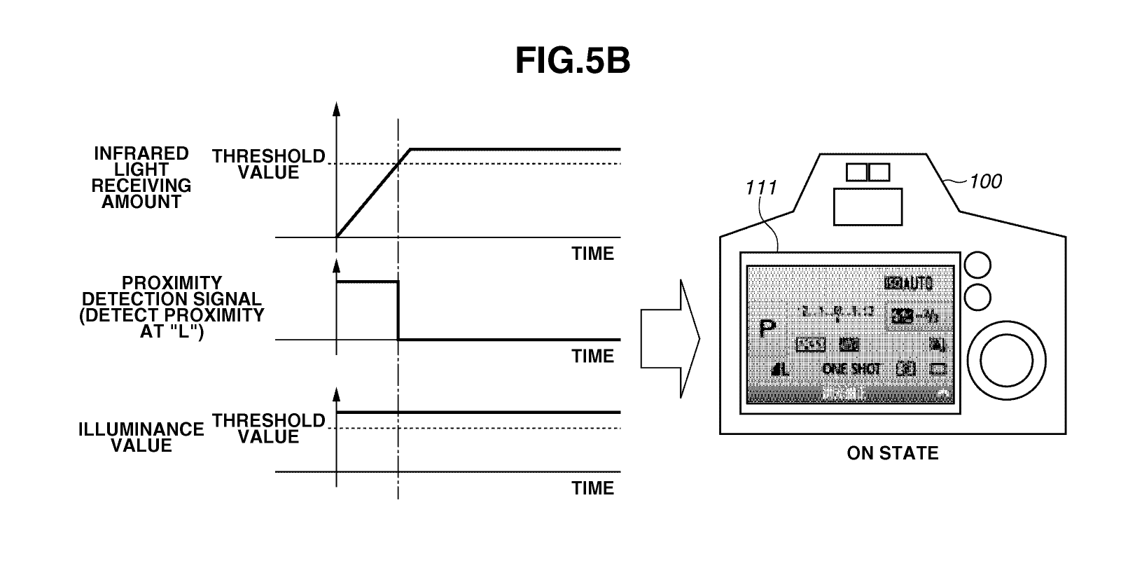

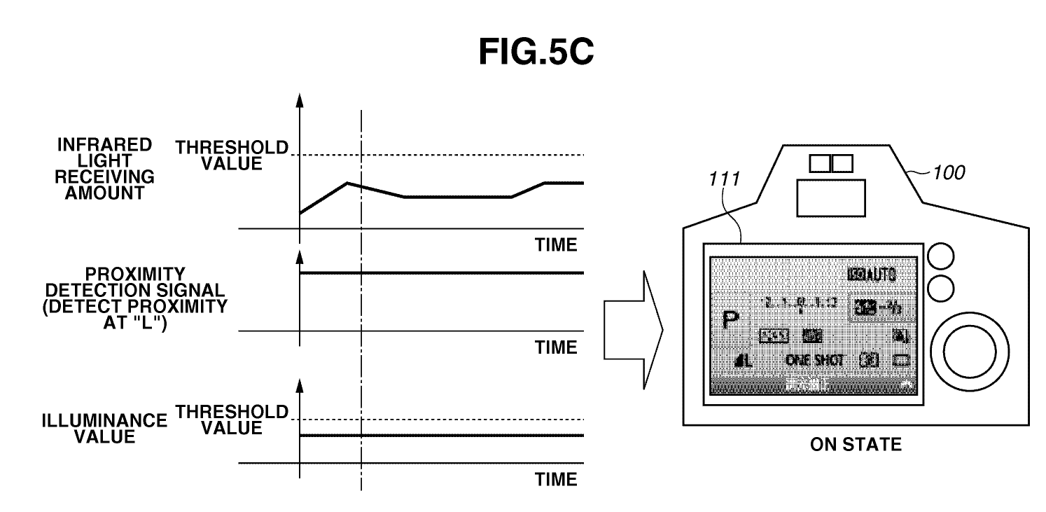

FIGS. 5A through 5C are diagrams illustrating examples of display states of the display device 111 that is controlled according to the proximity detection signal and the illuminance value.

FIG. 5A illustrates a state where the proximity detection signal is output while the illuminance value is equal to or less than the threshold value. This indicates that the detection target object 307 approaches the viewfinder 201, thus the proximity detection signal is output properly. Therefore, the system control unit 105 causes the backlight illumination unit 113 to perform an off-operation to turn off the display device 111.

FIG. 5B illustrates a state where the proximity detection signal is output while the illuminance value is greater than the threshold value. This indicates that the receiving amount of the infrared light exceeds the threshold value even though the detection target object 307 does not approach the viewfinder 201. This is the false detection which occurs when the illuminance of the ambient light is extremely high. In the image capturing apparatus 100 according to the present exemplary embodiment, the system control unit 105 can determine that the proximity detection signal is output due to false detection in which the proximity detection device 114 erroneously detects the infrared light contained in the ambient light as infrared light that is emitted from the light emitting element 302 and reflected on the detection target object 307. Therefore, the system control unit 105 causes the backlight illumination unit 113 to perform an on-operation to turn on the display unit 111.

FIG. 5C illustrates a state where the proximity detection signal is not output. In this case, the system control unit 105 causes the backlight illumination unit 113 to perform the on-operation to turn on the display device 111.

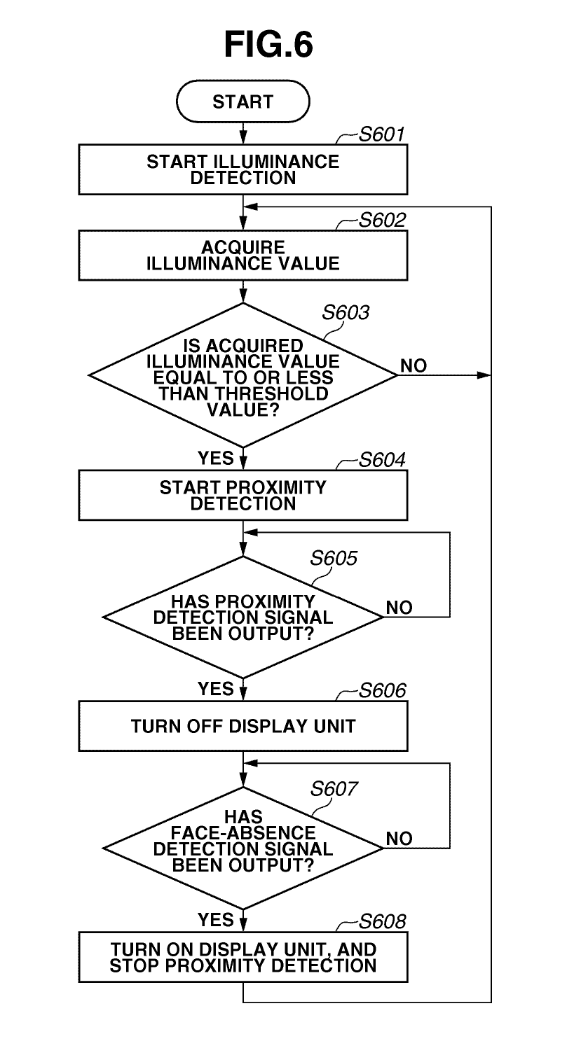

Hereinafter, the image capturing apparatus 100 according to a second exemplary embodiment of the present invention will be described with reference to a flowchart in FIG. 6. In the present exemplary embodiment, a method for preventing the display device 111 from being erroneously turned off when the proximity detection device 114 malfunctions due to the influence of the ambient light will be described. In this method, the electric power saving is also taken into consideration. The processing illustrated in FIG. 6 is realized when the system control unit 105 executes the program stored in the non-volatile memory 110 by loading the program onto the memory 106.

In step S601, the system control unit 105 controls the illuminance detection device 115 to start the illuminance detection operation. At this time, the system control unit 105 does not cause the proximity detection device 114 to start the proximity detection operation.

In step S602, the system control unit 105 causes the illuminance detection device 115 to detect the illuminance, and acquires an illuminance value at a predetermined interval. Then, the system control unit 105 stores the acquired illuminance value in the memory 106.

Next, in step S603, the system control unit 105 determines whether the illuminance value acquired in step S602 is equal to or less than a predetermined threshold value. If the illuminance value is equal to or less than the threshold value (YES in step S603), the system control unit 105 determines that the proximity detection device 114 does not make false detection caused by ambient light. Therefore, the processing proceeds to step S604. On the other hand, if the illuminance value acquired in step S602 is greater than the threshold value (NO in step S603), the proximity detection device 114 can make false detection caused by ambient light. Therefore, the proximity detection device 114 does not start the proximity detection, and the processing returns to step S602. Then, in step S602, the system control unit 105 acquires the illuminance value at the predetermined interval. Accordingly, the infrared light emitting element 302 does not emit the infrared light, while the light receiving element 305 does not receive the reflected light.

In step S604, the system control unit 105 controls the proximity detection device 114 to start the proximity detection operation. At this time, the infrared light emitting element 302 starts emitting the infrared light, while the light receiving element 305 starts receiving the reflected light.

In step S605, the system control unit 105 determines whether the proximity detection device 114 outputs a proximity detection signal. If the system control unit 105 determines that the proximity detection signal is output (YES in step S605), this indicates that the viewfinder 201 is in use. Therefore, the processing proceeds to step S606. On the other hand, if the system control unit 105 determines that the proximity detection signal is not output (NO in step S605), the processing returns to step S604. In step S604, the proximity detection device 114 continues the proximity detection operation while the display device 111 is kept to be turned on.

In step S606, the system control unit 105 causes the backlight illumination unit 113 to perform the off-operation to turn off the display device 111. With this, brightness of the display device 111 caused by the light supplied from the backlight illumination unit 113 is reduced, and the electric power can be saved. In addition, the system control unit 105 changes the input setting to disable the touch input with respect to the display device 111 (touch panel).

In step S607, the system control unit 105 determines whether the proximity detection device 114 outputs a face-absence detection signal. In a case where the face-absence detection signal is output (YES in step S607), this indicates that the user's face has been away from the viewfinder 201. Therefore, the processing proceeds to step S608. In a case where the face-absence detection signal is not output (NO in step S607), this indicates that the viewfinder 201 is still in use. Therefore, the processing returns to step S606, and the display device 111 is kept to be turned off.

In step S608, the system control unit 105 causes the backlight illumination unit 113 to perform the on-operation to turn on the display device 111 because the system control unit 105 determines that the user's face is away from the viewfinder 201 in step S607. Further, the system control unit 105 changes the input setting to enable the touch input with respect to the display device 111 (touch panel). In addition, the system control unit 105 controls the proximity detection device 114 to stop the proximity detection operation. Thereafter, the processing returns to step S602. In step S602, the system control unit 105 acquires the illuminance value at the predetermined interval.

The method according to the present exemplary embodiment, in which the display device 111 is prevented from being erroneously turned off when the proximity detection device 114 malfunctions due to the influence of the ambient light, which takes the electric power saving into consideration, has been described.

As described above, at first, the system control unit 105 controls the illuminance detection device 115 to operate. Then, the system control unit 105 causes the proximity detection device 114 to operate only when the illuminance value acquired from the illuminance detection device 115 is equal to or less than the threshold value. Through this, the display control device performs the proximity detection processing which takes an illuminance value into consideration while saving the electric power.

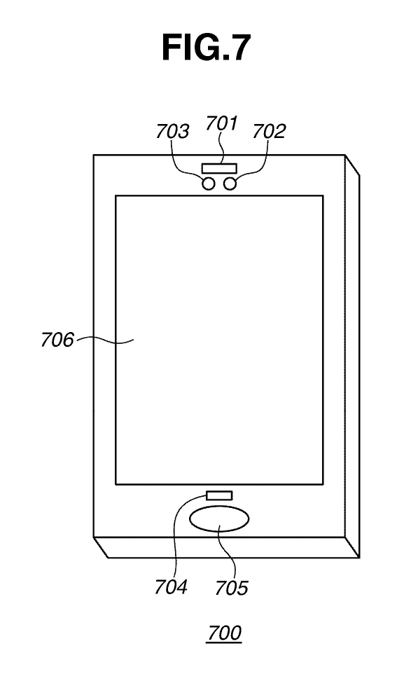

Herein, a third exemplary embodiment according to the present invention will be described with reference to FIG. 7.

FIG. 7 is a diagram illustrating an application example of a mobile phone which embodies the present invention.

As illustrated in FIG. 7, a mobile phone terminal (smartphone) 700 includes a call speaker 701 and a proximity detection device 702. The proximity detection device 702 detects the user's ear approaching the call speaker 701. The proximity detection device 702 is configured in a same manner as the proximity detection device 114 described in the first and the second exemplary embodiments. An illuminance detection device 703 is configured in a same manner as the above-described illuminance detection device 115. The mobile phone terminal 700 further includes a call microphone 704, an operation key 705, and a display unit 706. The display unit 706 includes a touch panel, which is a transparent panel capable of sensing the coordinates and disposed on top of the display screen.

In the mobile phone terminal 700 including the call speaker 701 which is configured as the above, when the user put his/her ear close to the call speaker 701 to make a call, the proximity detection device 702 detects the user's ear as an approaching object. When the proximity detection device 702 detects the approaching object, a system control unit (not illustrated) disposed within the mobile phone terminal 700 performs a display control for changing the display state of the display unit 706 from an on-state to an off-state. With this, brightness of the display unit 706 during a call is reduced, and the electric power can be saved. A control method for turning on and off the backlight illumination is employed as the display control method for the mobile phone terminal 700. However, a brightness adjustment control method for adjusting the brightness of the display unit 706 or a control method for setting the display unit 706 to a non-display mode may be employed as the display control method for the mobile phone terminal 700. Further, in order to prevent an erroneous operation due to an unintended touch input caused by the user's face touching the display unit 706, the system control unit changes the input setting to disable the touch input with respect to the display unit 706 (touch panel).

In the above-described mobile phone terminal 700, there is also a case where the proximity detection device 702 makes false detection caused by the infrared component contained in the ambient light. Even if the user does not put his/her ear close to the call speaker 701, for example, there may be a case where the display unit 706 is turned off, or the input setting of the touch panel is changed to disable the touch input. In such a case, the display control method described in the first and the second exemplary embodiments can also be applied. This method can prevent the proximity detection device 702 from making the false detection caused by the infrared light component contained in the ambient light, thereby preventing the display unit 706 from being erroneously turned off, and the touch input from being disabled. Thus, the operability thereof will not be degraded. Accordingly, even if the system control unit acquires a proximity detection signal output from the proximity detection device 702, the display unit 706 will not be turned off, and the touch input will not be disabled if the illuminance value detected by the illuminance detection device 703 exceeds a predetermined value. When the system control unit acquires a proximity detection signal output from the proximity detection device 702 while the illuminance value detected by the illuminance detection device 703 is equal to or less than the predetermined value, the system control unit controls the display unit 706 to be turned off, while controlling the touch input to be disabled. Alternatively, the system control unit may control the proximity detection device 702 not to operate the proximity detection operation itself when the illuminance value detected by the illuminance detection device 703 exceeds the predetermined value.

Incidentally, the illuminance detection device 703 can also be used as an illuminance detection device which detects illuminance when the brightness of the display unit 706 is adjusted according to the illuminance of the ambient light. Furthermore, the illuminance detection device 703 can be employed for a foldable mobile phone, and an image capturing apparatus provided with a variable-angle liquid crystal display (LCD) monitor where the viewing angle and the orientation thereof can be adjusted. In this case, the illuminance detection device 703 can be employed as an illuminance detection device which detects the illuminance for determining whether the display unit 706 is in a folded state (closed state) or in an opened state. In the folded state, the display unit 706 is folded (closed) in such a manner that a display surface thereof faces the other housing, whereas in the opened state, the display surface thereof is exposed. In addition, the above-described image capturing apparatus, which includes one housing, which is attached to the other housing in an openable/closable manner may include a determination unit configured to determine whether the display unit is in the opened state or in the closed state according to the illuminance value detected by the illuminance detection device 703.

Incidentally, a single piece of hardware may execute the entire control processing of the system control unit 105 with respect to the image capturing apparatus 100, or a plurality of pieces of hardware may share and execute the entire control processing thereof.

The above-described exemplary embodiments are merely the examples embodying the present invention, and each of the embodiments can be combined as appropriate.

In the above-described embodiments, an image capturing apparatus 100 and a mobile phone terminal 700 which embody the present invention are described as examples. However, the present invention is not limited thereto, and the invention is applicable to any device which includes an illuminance detection device, a proximity detection device, and a display device. Accordingly, the present invention can be applied to devices such as a personal computer, a personal digital assistance (PDA), a portable image viewer, a printing apparatus including a display device, a digital photo frame, a music player, a game machine, and an electronic book reader.

Aspects of the present invention can also be realized by a computer of a system or apparatus (or devices such as a CPU or MPU) that reads out and executes a program recorded on a memory device to perform the functions of the above-described embodiment (s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-274725 filed Dec. 15, 2011, which is hereby incorporated by reference herein in its entirety.

What is claimed is:

1. A display control device including a display unit, the display control device comprising:
a proximity detection unit configured to output a proximity detection signal when a predetermined condition to determine whether an object approaches the display control device is satisfied;
an illuminance detection unit configured to detect illuminance of ambient light; and
a control unit configured to control the display unit not to be turned off when the proximity detection unit outputs the proximity detection signal while the illuminance of ambient light detected by the illuminance detection unit is greater than a predetermined value, and to control the display unit to be turned off when the proximity detection unit outputs the proximity detection signal while the illuminance of ambient light detected by the illuminance detection unit is equal to or less than the predetermined value.

2. A display control device including a display unit, the display control device comprising:
a proximity detection unit configured to perform a proximity detection operation for detecting that an object approaches the display control device;
an illuminance detection unit configured to detect illuminance of ambient light; and
a control unit configured to control the proximity detection unit to perform the proximity detection operation when the illuminance of ambient light detected by the illuminance detection unit is equal to or less than a predetermined value, and to control the proximity detection unit not to perform the proximity detection operation when the illuminance of ambient light detected by the illuminance detection unit is greater than the predetermined value.

3. The display control device according to claim 1,
wherein the proximity detection unit includes an irradiation unit configured to emit infrared light and a light receiving unit configured to receive the infrared light that is reflected on a detection target object, and
wherein the proximity detection unit outputs the proximity detection signal when the light receiving unit receives the infrared light greater than a threshold value.

4. The display control device according to claim 1,
wherein the display control device includes an image capturing apparatus including an image capturing unit and a viewfinder, and
wherein the proximity detection unit detects that a face approaches the viewfinder.

5. The display control device according to claim 1,
wherein the display control device includes a phone terminal including a call speaker, and
wherein the proximity detection unit detects that an ear approaches the call speaker.

6. The display control device according to claim 1, further comprising an adjustment unit configured to adjust brightness of the display unit according to the illuminance detected by the illuminance detection unit.

7. The display control device according to claim 1,
wherein the display unit is attached to a housing, which constitutes the display control device, in an openable/closable manner relative to the housing, and
wherein the display control device further comprises a determination unit configured to determine whether the display unit is an opened state or a closed state according to the illuminance detected by the illuminance detection unit.

8. The display control device according to claim 1, further comprising a touch detection unit configured to detect a touch input with respect to the display unit,
wherein, when the control unit turns off the display unit according to the proximity detection signal output from the proximity detection unit, the control unit controls the display unit not to accept the touch input.

9. A control method for a display control device including a display unit, the control method comprising:
outputting a proximity detection signal when a predetermined condition to determine whether an object approaches the display control device is satisfied;
detecting illuminance of ambient light; and
controlling the display unit not to be turned off when the proximity detection signal is output while the detected illuminance of ambient light is greater than a predetermined value, and controlling the display unit to be turned off when the proximity detection signal is output while the detected illuminance of ambient light is equal to or less than the predetermined value.

10. A control method for a display control device including a display unit, the control method comprising:
performing a proximity detection operation for detecting that an object approaches the display control device;
detecting illuminance of ambient light; and
controlling the proximity detection operation to be performed when the detected illuminance of ambient light is equal to or less than a predetermined value, and controlling the proximity detection operation not to be performed when the detected illuminance of ambient light is greater than the predetermined value.

11. A non-transitory computer-readable storage medium storing a program that causes a computer to function as each unit of the display control device according to claim 1.

12. A non-transitory computer-readable storage medium storing a program that causes a computer to function as each unit of the display control device according to claim 2.
